(19) United States
(12) Patent Application Publication
(10) Pub. No.: US 2020/0012293 A1
(43) Pub. Date: Jan. 9, 2020

(54) ROBOT AND METHOD OF PROVIDING GUIDANCE SERVICE BY THE ROBOT

(71) Applicant: LG ELECTRONICS INC., Seoul (KR)

(72) Inventor: Seung Won LEE, Seoul (KR)

(73) Assignee: LG ELECTRONICS INC., Seoul (KR)

(21) Appl. No.: 16/578,036

(22) Filed: Sep. 20, 2019

(30) Foreign Application Priority Data
Aug. 27, 2019 (KR) 10-2019-0105274

(51) Int. Cl. G05D 1/02; B25J 9/16

(52) U.S. Cl. CPC G05D 1/0242; B25J 9/1666

(57) ABSTRACT

Disclosed are a robot and a method of providing a guidance service by the robot. A method of providing a guidance service by a robot according to an embodiment of the present disclosure may include receiving a guidance request from a user, determining a route to a destination based on the received guidance request, determining a field of vision based on the movement direction of the determined route, determining a projection area based on the determined field of vision and information on projectable surfaces, and projecting a laser beam indicating guidance information onto the determined projection area. In a 5G environment connected for the Internet of things, the method for recommending a location of a charging station is implemented by executing an artificial intelligence algorithm or machine learning algorithm.

### CROSS-REFERENCE TO RELATED APPLICATION

Pursuant to 35 U.S.C. § 119(a), this application claims the benefit of earlier filing date and right of priority to Korean Patent Application No. 10-2019-0105274, filed on Aug. 27, 2019, the contents of which are hereby incorporated by reference herein in its entirety.

### BACKGROUND

### 1. Technical Field

The present disclosure relates to a robot, and more particularly, to a robot configured to provide a guidance service to a user.

### 2. Description of Related Art

Recently, robots that may be conveniently used in daily life are being developed. Such robots are used to help people in their daily lives at home, school, and other public places.

A guidance robot may provide various services to the user, such as a road guidance service, boarding information guidance service, and other multimedia content providing service, in a large and congested space such as an airport, a terminal, and a shopping mall. The guidance robot may accompany the user to guide the user requesting road guidance to the destination.

Korean Patent Laid-Open Publication No. 10-2018-0039379 discloses a method of setting a moving route to travel positions necessary for boarding a plane, and guiding passengers to a boarding position by a robot for an airport according to a predetermined route.

However, in the congested space, the robot may not move at normal speed. Accordingly, it may take a long time for the robot to move to the destination. A user may wait for a robot in order to receive a guidance service, or the user may give up receiving the guidance service from the robot.

Accordingly, there is a demand for effectively providing a guidance service by using a robot in a congested space where the movement of the robot is limited.

### SUMMARY OF THE DISCLOSURE

An object of an embodiment of the present disclosure is to provide methods capable of effectively providing a guidance service in a congested space where the movement of the robot is limited.

Another object of an embodiment of the present disclosure is to provide methods capable of providing a guidance service while minimizing the movement of the robot.

Still another object of an embodiment of the present disclosure is to provide methods capable of providing a guidance service quickly and safely through a laser beam or an unmanned aerial vehicle without a robot moving to the destination.

The objects of the present disclosure are not limited to the objects described above, and other objects and advantages not described in the present disclosure may be understood by the following description and will be understood more reliably by an embodiment of the present disclosure. Moreover, aspects of the present disclosure may be realized by the means and combinations thereof indicated in claims.

A robot and a method of providing a guidance service by the robot according to an embodiment of the present disclosure is configured to determine a projection area based on information on a route to a destination and information on projectable surfaces, and to project a laser beam indicating guidance information onto the determined projection area.

The method of providing the guidance service by the robot according to an embodiment of the present disclosure may include receiving a guidance request from a user, determining a route to a destination based on the received guidance request, determining a field of vision based on the movement direction of the determined route, determining a projection area based on the determined field of vision and information on projectable surfaces, and projecting a laser beam indicating guidance information onto the determined projection area.

The information on the projectable surfaces may include coordinates indicating the boundaries of the projectable surfaces and an azimuth indicating the orientation of the projectable surfaces.

The projectable surfaces may include surfaces of a ceiling, a column, a wall, a handrail, or a floor.

The determining the projection area may include determining an area of the projectable surfaces included in the determined field of vision as the projection area.

The method may further include determining the guidance information based on at least one of the position or the area of the determined projection area, and the guidance information may include at least one of information on the destination, a distance to the destination, an estimated arrival time to the destination, a direction indication for guiding the determined route, a summary description for guiding the determined route, or landmark information.

The projecting the laser beam may include at least one of determining a projection time of the laser beam based on an estimated arrival time to the destination, or determining a projection intensity of the laser beam based on the distance to the determined projection area.

The method may further include, when the projection area may not be determined, determining an area of the projectable surfaces not included in the field of vision as an alternative projection area.

The method may further include moving to a position where the robot can project the laser beam to the alternative projection area, along the determined route.

The method may further include determining an alternative route to the destination based on the alternative projection area.

The method may further include, when the projection area may not be determined, receiving information on flight altitudes and flight ranges of other unmanned aerial vehicles in flight by other robots from a control server, limiting at least one of the flight altitude or the flight range of at least one unmanned aerial vehicle communicatively connected to the robot based on the received information, and controlling the at least one unmanned aerial vehicle so as to fly along the determined route within the limited flight altitude or flight range.

The method may include determining whether the limited flight altitude or flight range covers the destination, and transmitting a cooperation request to another robot configured to control another unmanned aerial vehicle capable of covering the destination, based on the determination that the limited flight altitude or flight range does not cover the destination, and the another unmanned aerial vehicle may fly to the destination along the remaining routes of the determined route on behalf of the at least one unmanned aerial vehicle, in response to the cooperation request.

A robot according to another embodiment of the present disclosure may include a user interface configured to receive a guidance request from a user, a beam driver configured to generate a laser beam, a memory configured to store information on projectable surfaces, and a controller configured to determine a route to a destination based on the guidance request, to determine a field of vision based on the movement direction of the determined route, to determine a projection area based on the determined field of vision and information on the projectable surfaces, and to control a beam driver so that a laser beam indicating guidance information is projected onto the determined projection area.

The information on the projectable surfaces may include coordinates indicating the boundaries of the projectable surfaces and an azimuth indicating the orientation of the projectable surfaces.

The projectable surfaces may include surfaces of a ceiling, a column, a wall, a handrail, or a floor.

The controller may determine an area of the projectable surfaces included in the determined field of vision as the projection area.

The controller may determine the guidance information based on at least one of the position or the area of the determined projection area, and the guidance information may include at least one of information on the destination, a distance to the destination, an estimated arrival time to the destination, a direction indication for guiding the determined route, a summary description for guiding the determined route, or landmark information.

The controller may determine a projection time of the laser beam based on an estimated arrival time to the destination, and determine a projection intensity of the laser beam based on the distance to the determined projection area.

When the projection area may not be determined, the controller may determine an area of the projectable surfaces not comprised in the field of vision as an alternative projection area.

When the projection area may not be determined, the controller may receive information on flight altitudes and flight ranges of other unmanned aerial vehicles in flight by other robots from a control server, limit at least one of the flight altitude or the flight range of at least one unmanned aerial vehicle communicatively connected to the robot based on the received information, and control the at least one unmanned aerial vehicle so as to fly along the determined route within the limited flight altitude or flight range.

The controller may determine whether the limited flight altitude or flight range covers the destination, and transmit a cooperation request to another robot configured to control another unmanned aerial vehicle capable of covering the destination, based on the determination that the limited flight altitude or flight range does not cover the destination, and the another unmanned aerial vehicle may fly to the destination along the remaining routes of the determined route on behalf of the at least one unmanned aerial vehicle, in response to the cooperation request.

According to an embodiment of the present disclosure, it is possible to effectively provide the guidance service even in the congested space where the movement of the robot is limited.

According to an embodiment of the present disclosure, it is possible to provide the guidance service while minimizing the movement of the robot, thereby improving overall robot system efficiency.

According to an embodiment of the present disclosure, it is possible to provide the guidance service more intuitively and quickly through the laser beam, thereby improving user satisfaction.

According to an embodiment of the present disclosure, it is possible to prevent the collision between the unmanned aerial vehicles, thereby providing the safe guidance service.

Effects of the present disclosure are not limited to the above-mentioned effects, and other effects, not mentioned above, will be clearly understood by those skilled in the art from the description of claims.

### BRIEF DESCRIPTION OF THE DRAWINGS

FIG. 1 is a diagram of a robot system according to an embodiment of the present disclosure.

FIG. 2 is a block diagram illustrating a configuration of a robot according to an embodiment of the present disclosure.

FIG. 3 is a diagram illustrating a robot according to an embodiment of the present disclosure.

FIG. 4 is an exemplary diagram for explaining an operation in which a robot determines a projection area according to an embodiment of the present disclosure.

FIG. 5 is an exemplary diagram of guidance information projected by a robot according to an embodiment of the present disclosure.

FIG. 6 is another exemplary diagram projected to an alternative projected area by a robot according to an embodiment of the present disclosure.

FIG. 7 is a flowchart illustrating a method of providing a guidance service by a robot according to an embodiment of the present disclosure.

FIG. 8 is a diagram for explaining a robot according to another embodiment of the present disclosure.

FIGS. 9A and 9B are diagrams for explaining that a flight altitude and a flight range are limited by a robot according to another embodiment of the present disclosure.

FIG. 10 is a flowchart illustrating a method of providing a guidance service by a robot according to another embodiment of the present disclosure.

FIG. 11 is a diagram illustrating a robot system according to another embodiment of the present disclosure.

### DETAILED DESCRIPTION

In what follows, embodiments disclosed in this document will be described in detail with reference to appended drawings, where the same or similar constituent elements are given the same reference number irrespective of their drawing symbols, and repeated descriptions thereof will be omitted. In the following description, the terms “module” and “unit” for referring to elements are assigned and used exchangeably in consideration of convenience of explanation, and thus, the terms per se do not necessarily have different meanings or functions. Also, in describing an embodiment disclosed in the present document, if it is determined that a detailed description of a related art incorporated herein unnecessarily obscure the gist of the embodiment, the detailed description thereof will be omitted. Also, it should be understood that the appended drawings are intended only to help understand embodiments disclosed in the present document and do not limit the technical principles and scope of the present disclosure; rather, it should be understood that the appended drawings include all of the modifications, equivalents or substitutes described by the technical principles and belonging to the technical scope of the present disclosure.

It will be understood that, although the terms “first”, “second”, and the like may be used herein to describe various elements, these elements should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

A robot may refer to a machine which automatically handles a given task by its own ability, or which operates autonomously. In particular, a robot having a function of recognizing an environment and performing an operation according to its own judgment may be referred to as an intelligent robot.

Robots may be classified into industrial, medical, household, and military robots, according to the purpose or field of use.

A robot may include an actuator or a driver including a motor in order to perform various physical operations, such as moving joints of the robot. Moreover, a movable robot may include, for example, a wheel, a brake, and a propeller in the driver thereof, and through the driver may thus be capable of traveling on the ground or flying in the air.

Autonomous driving refers to a technology in which driving is performed autonomously, and an autonomous vehicle refers to a vehicle capable of driving without manipulation of a user or with minimal manipulation of a user.

For example, autonomous driving may include a technology in which a driving lane is maintained, a technology such as adaptive cruise control in which a speed is automatically adjusted, a technology in which a vehicle automatically drives along a defined route, and a technology in which a route is automatically set when a destination is set.

A vehicle includes a vehicle having only an internal combustion engine, a hybrid vehicle having both an internal combustion engine and an electric motor, and an electric vehicle having only an electric motor, and may include not only an automobile but also a train and a motorcycle.

In this case, an autonomous vehicle may be considered as a robot with an autonomous driving function.

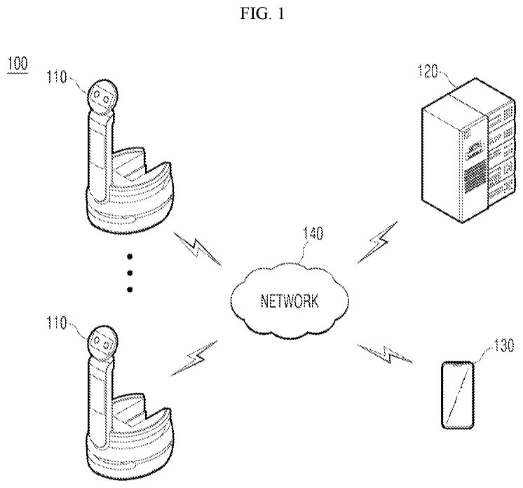

FIG. 1 is a diagram of a robot system according to an embodiment of the present disclosure. Referring to FIG. 1, a robot system according to an embodiment of the present disclosure includes one or more robots 110 and a control server 120, and may optionally further include a terminal 130.

The one or more robots 110, the control server 120, and the terminal 130 may be connected to each other via a network 140. One or more robots 110, the control server 120, and the terminal 130 may also communicate with each other through a base station, but may also communicate directly with each other without a base station.

The one or more robots 110 may perform a task in a space, and provide information or data related to the task for the control server 120. A workspace of a robot may be indoors or outdoors. A robot may be operated in a space predefined by a wall or a column. In this case, a workspace of a robot may be defined in various ways depending on the design purpose, working attributes of the robot, mobility of the robot, and other factors. A robot may be operated in an open space, which is not predefined. The robot may also sense a surrounding environment and determine a workspace by its own accord.

The one or more robots 110 may provide their state information or data to the control server 120. The state information of the robot 110 may include information on the position, a battery level, a durability of component, a replacement cycle of consumables, and the like of the robot 110.

The control server 120 may perform various analysis based on information or data provided by the one or more robots 110, and control overall operation of a robot system based on the analysis result. In an aspect, the control server 120 may directly control driving of the robot 110 based on the analysis result. In another aspect, the control server 120 may derive and output useful information or data from the analysis result. In still another aspect, the control server 120 may adjust parameters in a robot system using the derived information or data. The control server 120 may be implemented as a single server but may be implemented as a plurality of server sets, a cloud server, or a combination thereof.

The terminal 130 may share the role of the control server 120. In an aspect, the terminal 130 may obtain information or data from the one or more robots 110 and provide the information or data for the control server 120, or may obtain information or data from the control server 120 and provide the information or data for the one or more robots 110. In another aspect, the terminal 130 may share at least a portion of analysis to be performed by the control server 120, and may provide a result of the analysis for the control server 120. In still another aspect, the terminal 130 may receive an analysis result, information, or data from the control server 120, and may simply output the analysis result, information, or data.

The terminal 130 may replace the control server 120. At least one robot of a plurality of robots 110 may replace the control server 120. In this case, the plurality of robots 110 may be connected to communicate with each other.

The terminal 130 may include various electronic devices capable of communicating with the robot 110 and the control server 120. The terminal 130 may be implemented as a stationary terminal and a mobile terminal, such as a mobile phone, a projector, a cellular phone, a smartphone, a laptop computer, a terminal for digital broadcast, a personal digital assistant (PDA), a portable multimedia player (PMP), a navigation system, a slate PC, a tablet PC, an ultrabook, a wearable device (for example, a smartwatch, a smart glass, and a head mounted display (HMD)), a set-top box (STB), a digital multimedia broadcast (DMB) receiver, a radio, a laundry machine, a refrigerator, a desktop computer, and digital signage.

The network 140 may refer to a network which composes a portion of a cloud computing infrastructure or which is provided in a cloud computing infrastructure. The network 140 may be, for example, a wired network such as local area networks (LANs), wide area networks (WANs), metropolitan area networks (MANs), or integrated service digital networks (ISDNs), or a wireless communications network such as wireless LANs, code division multi access (CDMA), Wideband CDMA (WCDMA), long term evolution (LTE), long term evolution-advanced (LTE-A), 5G (generation) communications, Bluetooth™, or satellite communications, but is not limited thereto.

The network 140 may include connection of network elements such as hubs, bridges, routers, switches, and gateways. The network 140 may include one or more connected networks, for example, a multi-network environment, including a public network such as an internet and a private network such as a safe corporate private network. Access to the network 140 may be provided through one or more wire-based or wireless access networks. Further, the network 140 may support various types of machine-to-machine (M2M) communications (for example, Internet of Things (IoT), Internet of Everything (IoE), Internet of Small Things (IoST)), transmitting and receiving information between distributed components such things to process the information, and/or 5G communications.

In a congested space such as an airport, a terminal, or a shopping mall, as the robot 110 may not move at a normal speed, it is difficult to provide an effective guidance service by the robot 110. The user may have to wait for the robot 110 to receive the guidance service, or may give up receiving the guidance service from the robot 110.

Accordingly, embodiments of the present disclosure are to provide methods capable of effectively providing a guidance service in a congested space where the movement of the robot is limited.

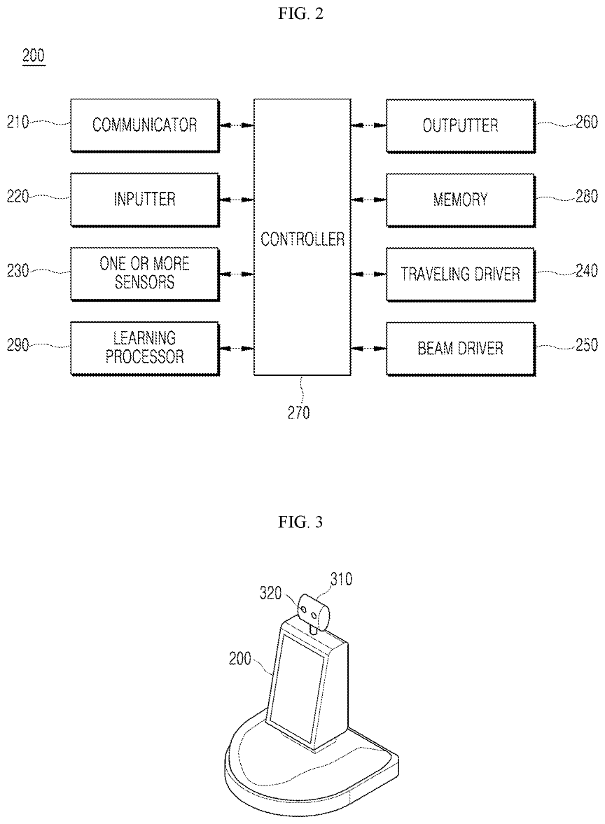

FIG. 2 is a block diagram illustrating a configuration of a robot according to an embodiment of the present disclosure, and FIG. 3 is a diagram illustrating a robot according to an embodiment of the present disclosure.

Referring to FIG. 2, the robot 200 according to an embodiment of the present disclosure may include a communicator 210, an inputter 220, one or more sensors 230, a traveling driver 240, a beam driver 250, an outputter 260, a controller 270, and a memory 280. The robot 200 may further include a learning processor 290 in order to perform an operation related to artificial intelligence and/or machine learning.

The communicator 210 may transmit or receive information or data with external devices such as a control server 120, a terminal 130, or an Unmanned Aerial Vehicle (UAV) such as a drone by using wired or wireless communication technology.

For example, the communicator 210 may transmit or receive sensor data, user input, a learning model, a control signal, and the like with the external devices. The communicator 210 may use the communication technology, such as Global System for Mobile communication (GSM), Code Division Multi Access (CDMA), Long Term Evolution (LTE), 5G, Wireless LAN (WLAN), Wireless-Fidelity (Wi-Fi), Bluetooth™, Radio Frequency Identification (RFID), Infrared Data Association (IrDA), ZigBee, and Near Field Communication (NFC).

In an embodiment, the communicator 210 may receive a guidance request from the user's terminal 130. The communicator 210 may provide the received guidance request to the controller 270. The guidance request indicates a request for a guidance service provided by the robot 200. The guidance service may include a road guidance service, a boarding information guidance service, or other multimedia content providing service. If the guidance request is for the road guidance service, the guidance request may include destination information and position information of the terminal 130.

The inputter 220 may obtain various types of data. The inputter 220 may include at least one camera for obtaining a video signal, a microphone for obtaining an audio signal, and a user interface for receiving information from a user.

The inputter 220 may obtain, for example, learning data for model learning and input data used when output is obtained using a learning model. The inputter 220 may obtain raw input data. In this case, the controller 270 or the learning processor 290 may extract an input feature by preprocessing the input data.

In an embodiment, the inputter 220 may receive the guidance request from the user through a user interface. The inputter 220 may provide the received guidance request to the controller 270. The guidance request indicates a request for a guidance service provided by the robot 200. The guidance service may include a road guidance service, a boarding information guidance service, or other multimedia content providing service. If the guidance request is for the road guidance service, the guidance request may include destination information.

One or more sensors 230 may obtain at least one of internal information of the robot 200, surrounding environment information of the robot 200, or user information by using various sensors. The one or more sensors 230 may include an acceleration sensor, a magnetic sensor, a gyro sensor, an inertial sensor, a proximity sensor, an RGB sensor, an IR sensor, an illuminance sensor, a temperature sensor, a humidity sensor, a fingerprint sensor, an ultrasonic sensor, an optical sensor, a microphone, a Lidar, a Radar, any combination thereof, or the like.

The traveling driver 240 physically drives the robot 200. The traveling driver 240 may include an actuator or a motor that operates according to a control signal from the controller 270. The traveling driver 240 may include a wheel, a brake, a propeller, or the like operated by the actuator or the motor.

The beam driver 250 projects a laser beam on a specific area according to the control signal from the controller 270. The beam driver 250 may operate a light emitter configured to generate a laser beam and an adjuster configured to adjust a projection height, a projection direction, a projection angle, and the like of the laser beam generated from the light emitter. The beam driver 250 may include an actuator or a motor that operates the adjuster. FIG. 3 illustrates an example of a light emitter 320 and an adjuster 310 formed on the head of the robot 200. On the contrary, the light emitter and the adjuster may be combined as a separate device in various other positions such as an arm or a shoulder of the robot 200. The beam driver 250 may generate a laser beam so that guidance information is projected on a specific area by using various methods applied to a beam projector, a laser beam advertisement device, or the like.

The outputter 260 may generate a visual, auditory, or tactile related output. The outputter 260 may include a display unit outputting visual information, a speaker outputting auditory information, and a haptic module outputting tactile information.

The memory 280 may store data supporting various functions of the robot 200. The memory 280 may store information or data received by the communicator 210, and input information, input data, learning data, a learning model, and a learning history obtained by the inputter 220.

The memory 280 may store map information of the space and information on structures in the space. The structures may include, but are not limited to, a ceiling, a wall, a column, a railing, a floor, or the like having at least one projectable surface on which a laser beam may be projected. The structures may include various types of machines, instruments, articles, etc., having at least one projectable surface and fixed in space.

Information on the structures may include information on projectable surfaces. The information on the projectable surfaces may include a plurality of coordinates indicating the boundaries of the surfaces to which the laser beam may be projected and an azimuth angle indicating the orientation of the corresponding surfaces. The plurality of coordinates may be two-dimensional coordinate or three-dimensional coordinate. The information on the projectable surfaces may further include information on the material or color of the corresponding surfaces.

For example, if the structure is a square column and a laser beam may be projected on three of four surfaces, the information on the projectable surfaces may include information on a plurality of three-dimensional coordinates indicating the boundaries of the three surfaces and the azimuth angle, a material (for example, concrete), a color (for example, white), or the like of each of the three surfaces. The information on the projectable surfaces may be collected in advance by the robot 200 to be stored in the memory 280, and may be updated periodically.

The controller 270 may determine at least one executable operation of the robot 200 based on information determined or generated by using a data analysis algorithm or a machine learning algorithm. In addition, the controller 270 may control components of the robot 200 to perform the determined operation.

The controller 270 may request, retrieve, receive, or use information or data of the learning processor 290 or the memory 280, and may control components of the robot 200 to execute a predicted operation or an operation determined to be preferable of the at least one executable operation. When the controller 270 needs to be connected with an external device such as the control server 120, the terminal 130, or an unmanned aerial vehicle in order to perform the determined operation, the controller 270 may generate a control signal for controlling the corresponding external device, and transmit the generated control signal to the corresponding external device.

The controller 270 may control at least some of components of the robot 200 to drive an application stored in the memory 280. Furthermore, the controller 270 may operate two or more components included in the robot 200 in combination with each other to drive the application.

The controller 270 may provide the guidance service to the user by controlling the beam driver 250 based on the guidance request received from the user through the inputter 220 or the communicator 210. The controller 270 may provide a guidance service by projecting a laser beam indicating guidance information onto a projection area.

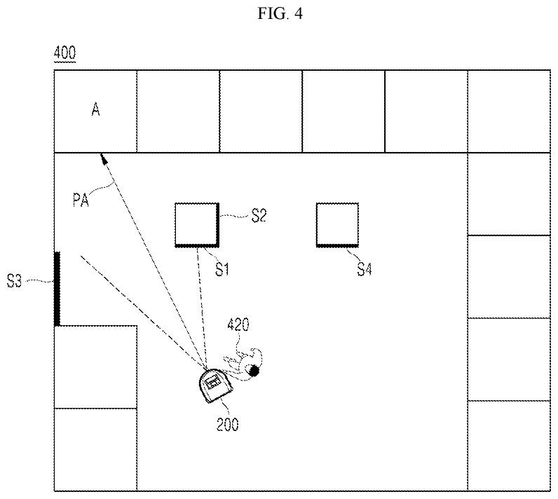

The controller 270 may visually display guidance information on a route or a projection area to the destination through a display of the outputter 260 or output a voice through a speaker of the outputter 260. Hereinafter, specific operations of the controller 270 will be described with reference to FIGS. 4 to 6.

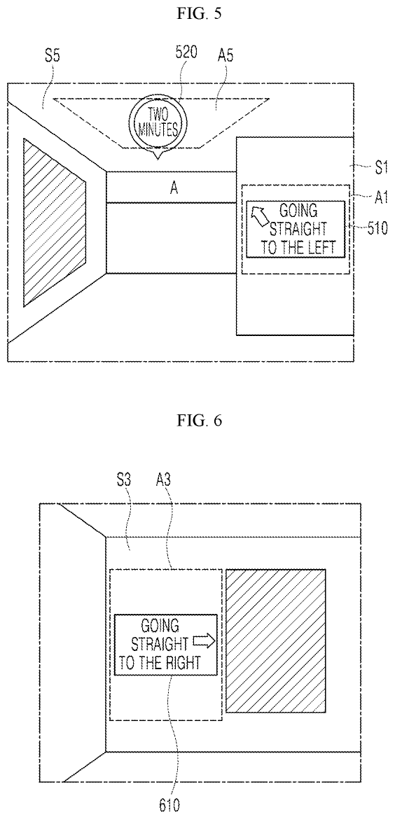

FIG. 4 is an exemplary diagram for explaining an operation in which a robot determines a projection area according to an embodiment of the present disclosure. FIG. 5 is an exemplary diagram of guidance information projected onto a projection area by a robot according to an embodiment of the present disclosure, and FIG. 6 is another exemplary diagram of guidance information projected onto an alternative projection area by a robot according to an embodiment of the present disclosure. Another illustration.

FIG. 4 illustrates a plane diagram of a space 400. In the space 400, the robot 200 and a user 420 are briefly illustrated. The portions indicated by the dark line in the space 400 may represent projectable surfaces S1, S2, S3, and S4. The surfaces S1, S2, S4 may be surfaces of a pillar, and the surface S3 may be a surface of a wall. The ceiling or the floor is not illustrated in the plane diagram of FIG. 4. However, as illustrated in FIG. 5, the surface S5 of the ceiling may also be a projectable surface.

The controller 270 may determine a route from the current position of the robot 200 or the current position of the user 420 to the destination based on a guidance request from the user. In an embodiment, when the guidance request to the destination is received from the inputter 220, the current position of the robot 200 and the current position of the user 420 may be substantially the same. In another embodiment, when the guidance request to the destination is received through the communicator 210, the user 420 and the robot 200 may be spaced at a certain distance or more apart from each other. In this case, the current position of the terminal 130 that has transmitted the guidance request may also be determined as the current position of the user 420. In some embodiments, the controller 270 may also determine or calibrate the current position of the user 420 based on an image signal from a camera of the inputter 220 or sensor data from the one or more sensors 230.

The controller 270 may refer to map information of the space 400 stored in the memory 280 to determine a route. The controller 270 may determine a shortest route, an alternative route, an expected arrival time, and the like to the destination by using various methods known to those skilled in the art. For example, as illustrated in FIG. 4, the controller 270 may determine a first route PA based on the guidance request to a destination A.

The controller 270 may determine a field of vision based on the movement direction of the determined route. The controller 270 may determine a range within a predetermined angle as a field of vision with respect to the movement direction of the determined route. Here, the predetermined angle may be variously selected according to the distance to the destination, the area of the space, the degree of congestion of the space, and the like. For example, the field of vision for the first route PA in FIG. 4 may be determined as indicated by the dotted line. The field of vision may indicate a range that is naturally visible to the user 420 in a state where the eyes of the user 420 face the movement direction of the determined route. Although the field of vision has been illustrated on the two-dimensional plan diagram in FIG. 4 for convenience of description, the field of vision may represent a three-dimensional space.

The controller 270 may determine a projection area onto which the laser beam is projected based on the determined field of vision. The controller 270 may refer to information on projectable surfaces stored in the memory 280 to determine a projection area. In an embodiment, the controller 270 may determine, as the projection area, one area of the projectable surfaces included in the determined field of vision. For example, referring to FIGS. 4 and 5, the controller 270 may determine an area A1 of the surface S1 or an area A5 of the surface S5 included in the determined field of vision as the projection area. Since the surfaces S3, and S4 are not included in the determined field of vision, they are not determined as the projection area.

The controller 270 may determine guidance information to be projected onto the determined projection area. In an embodiment, the controller 270 may determine the guidance information to be projected based on at least one of the position or area of the determined projection area.

The information that may be included in the guidance information may include destination information, distance to the destination, an estimated arrival time to the destination, direction indication for route guidance, summary description for route guidance, landmark information, any combination thereof, or the like. The destination information may include summary information on the destination such as an indication of the destination, a name or an attribute of the destination, and the like. The distance to the destination may be expressed in meters (m), or the like, and the estimated arrival time to the destination may be expressed in hours, minutes, and the like. Direction indication for route guidance may include various types of figures that may indicate a direction such as arrows or triangles. The summary description for the route guidance may include a description such as going straight, left turning, and right turning. The landmark information may indicate information on a structure, a shop, or the like that is highly distinguished or famous in a space. In some cases, it may be more effective to guide a route by using landmark information.

In an embodiment, the controller 270 may determine the guidance information according to the position of the determined projection area. For example, as illustrated in FIG. 5, the controller 270 may include the arrow and the summary description for the route guidance in the guidance information 510. For another example, as illustrated in FIG. 5, the controller 270 may include the estimated arrival time to the destination in the guidance information 520 together with the indication of the destination A.

In an embodiment, the controller 270 may determine the guidance information according to the area of the determined projection area. That is, the controller 270 may select information to be included in the guidance information according to the area of the projection area. The controller 270 may include relatively more information in the guidance information as the area of the projection area is relatively larger.

The controller 270 may control the beam driver 250 so that the determined guidance information is projected onto the determined projection area. The controller 270 may generate a control signal to provide it to the beam driver 250. The control signal may include a first control signal for controlling the light emitter and a second control signal for controlling the adjuster.

The controller 270 may generate the first control signal including control information such as a projection intensity or a projection time of the laser beam. In an embodiment, the controller 270 may determine the projection intensity of the laser beam based on the distance to the determined projection area. For example, when the projection area A5 is located farther than the projection area A1 in FIG. 5, the intensity of the laser beam projected onto the projection area A5 is stronger than that of the laser beam projected onto the projection area A1. In another embodiment, the controller 270 may determine the projection time of the laser beam based on the estimated arrival time to the destination. For example, the guidance information may be projected onto the projection area A5 for a time less than two minutes, which is an expected arrival time to the destination A in FIG. 5.

The controller 270 may generate the second control signal including control information such as coordinates indicating the boundary of the determined projection area, an azimuth indicating the orientation of the determined projection area, a projection angle, a projection direction, or a projection height of the laser beam, and the like.

In the above-described embodiments, there are projectable surfaces within the determined field of vision. However, there may be a case where the projection area may not be determined because there are no projectable surfaces within the determined field of vision.

For this case, some embodiments of the present disclosure provide two approaches. The first approach is to consider an alternative projection to other projectable surfaces. For this purpose, the robot 200 may move a certain distance along the determined route or an alternative route may be determined. The second approach is to have the unmanned aerial vehicle fly along the determined route to guide the user to the destination. The latter approach will be described below with reference to FIGS. 8 to 10, and the former approach is first described with reference to FIG. 6.

In FIGS. 4 and 5, it is assumed that the laser beam may not be projected onto the surfaces S1, and S5 due to the presence of an obstacle or the like. As described, if there are no projectable surfaces within the determined field of vision, the controller 270 may consider an alternative projection to other projectable surfaces not included in the determined field of vision, for example, the surfaces S2, S3, and S4 of FIG. 4.

In an embodiment, the controller 270 may consider surfaces that are not included in the determined field of vision but may be projected by the laser beam at the current position. For example, in FIG. 4 the surface S4 is not included in the determined field of vision, but the projection of the laser beam is possible at the current position. Accordingly, the controller 270 may determine an area of the surface S4 as an alternative projection area. In this case, even though the guidance information is projected onto the surface S4, it may not be suitable for guiding the first route PA. Accordingly, when determining the projection onto the surface S4, the controller 270 may determine an alternative route of the first route PA. In FIG. 4, the alternative route may be a route between two central columns. This approach may be useful when a difference between the expected arrival time of the alternative route and the expected arrival time of the first route PA is not large.

In another embodiment, the controller 270 may determine whether there are other projectable surfaces near the determined route. For example, in FIG. 4, assuming that the robot 200 moves along the determined first route PA, a laser beam may be projected onto the surface S3 according to the movement of the robot 200. Accordingly, the controller 270 may determine an area of the surface S3 as an alternative projection area. In this case, the controller 270 may control the traveling driver 240 to move the robot 200 to a position where the laser beam may be projected onto the surface S3. Thereafter, the controller 270 may control the beam driver 250 to project guidance information 610 illustrated in FIG. 6 onto an area A3 of the surface S3. According to this approach, the guidance service may be provided while the optimal route is maintained. The robot 200 may provide the guidance service by accompanying the user 420 only up to a predetermined position and projecting a laser beam for the remaining routes.

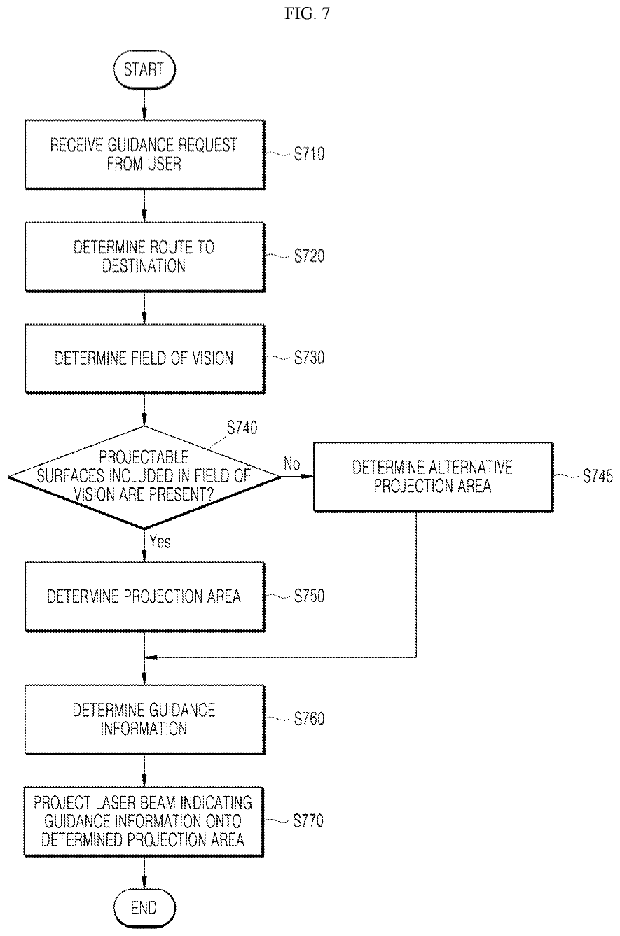

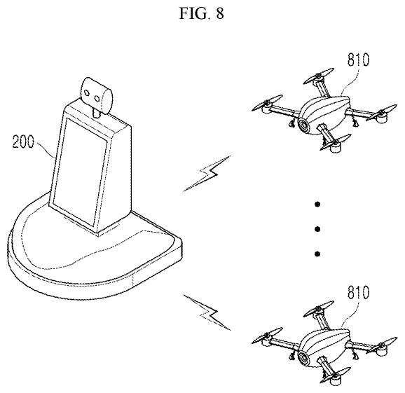

FIG. 7 is a flowchart illustrating a method of providing a guidance service by a robot according to an embodiment of the present disclosure. The method, illustrated in FIG. 7, may be performed by the robot 200 in FIG. 2.

In step S710, the robot 200 receives a guidance request from the user. The guidance request from the user may include destination information.

In step S720, the robot 200 determines a route to the destination based on the received guidance request.

In step S730, the robot 200 determines a field of vision based on the movement direction of the determined route. The field of vision may be determined as a range within a predetermined angle with respect to the movement direction of the determined route. The predetermined angle may be variously selected according to the distance to the destination, the area of the space, the congestion degree of the space, and the like.

In step S740, the robot 200 determines whether there are projectable surfaces included within the determined field of vision. For this purpose, the robot 200 may refer to information on the projectable surfaces stored in the memory 280.

If there are projectable surfaces included in the determined field of vision, in step S750, the robot 200 determines an area of the projectable surfaces included in the determined field of vision as a projection area.

In step S760, the robot 200 determines guidance information based on the determined projection area. The robot 200 may determine information to be included in the guidance information according to the position and area of the determined projection area.

In step S770, the robot 200 may project a laser beam indicating guidance information onto the determined projection area.

If there are no projectable surfaces within the determined field of vision, in step S745, the robot 200 may determine an alternative projection area to proceed to step S760.

In an embodiment, the robot 200 may determine, as an alternative projection area, an area of the surfaces that is not included in the determined field of vision but may be projected by the laser beam at the current position. The robot 200 may determine an alternative route based on the determined alternative projection area.

In another embodiment, the robot 200 may determine, as an alternative projection area, an area of the surfaces that is impossible to be projected at the current position but may be projected by moving along the determined route. The robot 200 may project a laser beam after moving to a position where projection to an alternative projection area becomes possible.

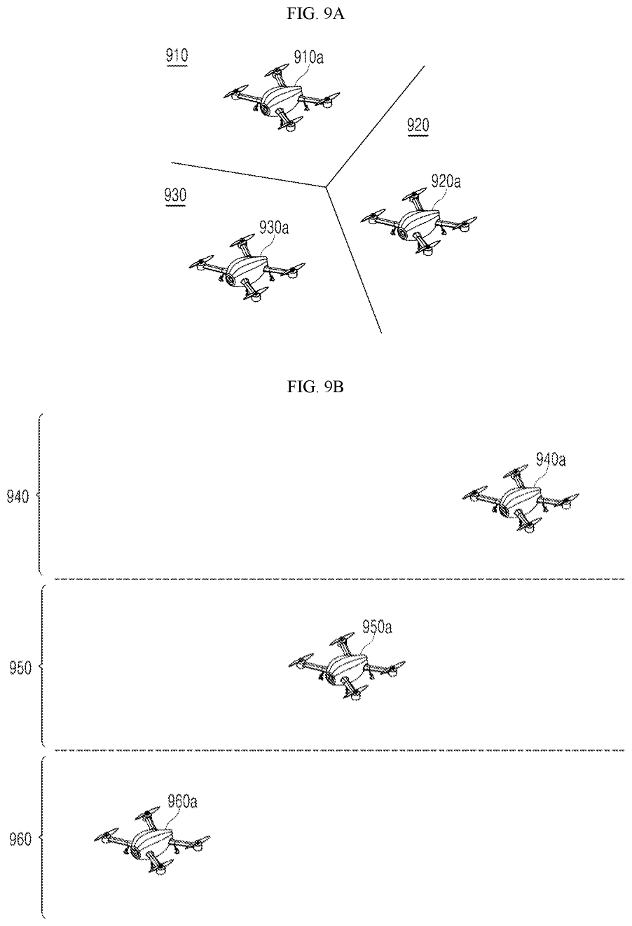

FIG. 8 is a diagram illustrating a robot according to an embodiment of the present disclosure. FIG. 9 is a diagram for explaining that a flight altitude and a flight range are limited by a robot according to another embodiment of the present disclosure.

As described above, a method of guiding a user to a destination by using an unmanned aerial vehicle may be considered when the projection area may not be determined.

Referring to FIG. 8, the robot 200 may be communicatively connected with at least one unmanned aerial vehicle 810. In an embodiment, the unmanned aerial vehicle 810 may be dedicated to the robot 200. That is, the unmanned aerial vehicle 810 may be accessible only by the robot 200. The unmanned aerial vehicle 810 may also be located at a predetermined waiting place in the space, or may also be mounted or held on a portion of the robot 200.

In an embodiment, when the projection area may not be determined, the controller 270 may control the unmanned aerial vehicle 810 so as to fly along the determined route to guide the user to the destination.

However, there may be a number of robots in the space, and accordingly, a number of unmanned aerial vehicles may be in flight. Indiscriminate flying of unmanned aerial vehicles may cause collisions between the unmanned aerial vehicles or collisions between the unmanned aerial vehicle and persons. Accordingly, some embodiments of the present disclosure provide a method of limiting at least one of a flight altitude or a flight range of the unmanned aerial vehicle 810.

In an embodiment, when determining the flight of the unmanned aerial vehicle 810, the controller 270 may receive information on flight altitudes and flight ranges of other unmanned aerial vehicles in flight by other robots from the control server 120. The controller 270 may limit at least one of the flight altitude or the flight range of the unmanned aerial vehicle 810 based on the received information. The controller 270 may limit the flight altitude or the flight range of the unmanned aerial vehicle 810 so as not to overlap the flight altitudes and the flight ranges of other unmanned aerial vehicles.

The controller 270 may transmit a control signal to the unmanned aerial vehicle 810 through the communicator 210 so as to fly the determined route within a limited flight altitude or flight range.

FIG. 9 shows a situation where the flight altitudes or the flight ranges of the unmanned aerial vehicles are limited. Referring to FIG. 9A, an unmanned aerial vehicle 910a may fly only within a flight range 910, an unmanned aerial vehicle 920a may fly only within a flight range 920, and an unmanned aerial vehicle 930a may fly only within a flight range 930. Referring to FIG. 9B, an unmanned aerial vehicle 940a may fly only at a flight altitude 940, an unmanned aerial vehicle 950a may fly only at a flight altitude 950, and an unmanned aerial vehicle 960a may fly at a flight altitude 960.

Due to flight altitude or flight range limitations, the unmanned aerial vehicle 810 may not be able to fly to its destination. For example, the destination is the second floor in a space where a plurality of floors have been open, such as an airport or a shopping mall, but the flight on the second floor of the unmanned aerial vehicle 810 may be limited. For another example, when the distance from the robot 200 to the destination is far, flight around the destination of the unmanned aerial vehicle 810 may be limited.

In an embodiment, if the limited flight altitude or flight range does not cover the destination, the controller 270 may send a cooperation request to another robot that controls another unmanned aerial vehicle capable of covering the destination. If another robot approves the cooperation request, the cooperative guidance of the robot 200 and another robot may be made.

In the example illustrated in FIG. 9A, when the destination belongs to the flight range 920, the unmanned aerial vehicle 910a may guide the user to the boundary point between the flight range 910 and the flight range 920, and then the unmanned aerial vehicle 920a may guide the user from the boundary point to the destination.

In the example illustrated in FIG. 9B, when the destination belongs to the flight altitude 950, the unmanned aerial vehicle 960a may guide the user to the boundary point between the flight altitude 960 and the flight altitude 950, and then the unmanned aerial vehicle 950a may guide the user from the boundary point to the destination.

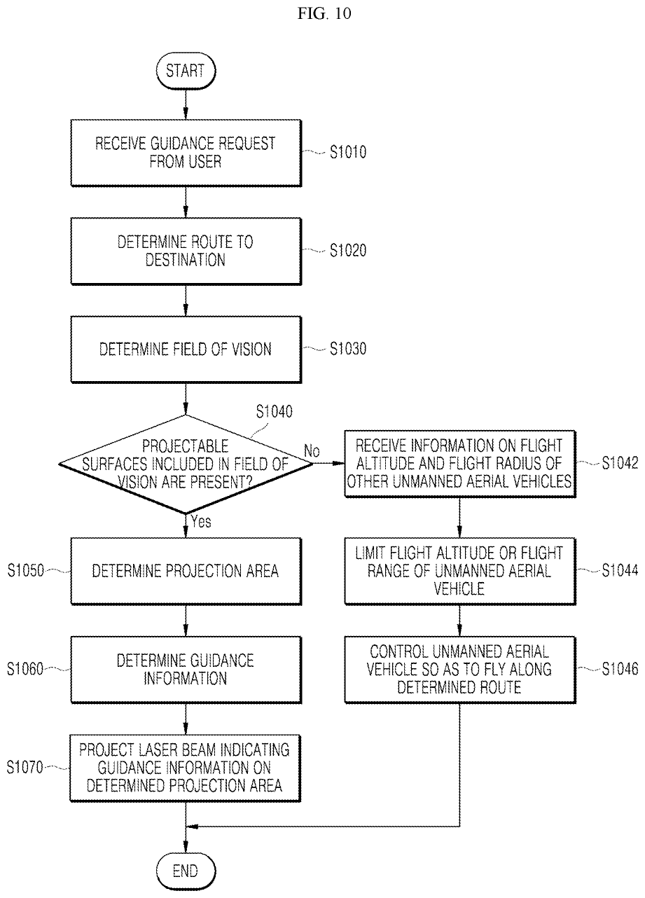

FIG. 10 is a flowchart illustrating a method of providing a guidance service by a robot according to another embodiment of the present disclosure. FIG. 10 may be performed by the robot 200 illustrated in FIG. 8.

Since steps S1010 to S1070 are substantially the same as the steps S710 to S770 illustrated in FIG. 7, a detailed description thereof will be omitted.

If there are no projectable surfaces included in the field of vision determined in step S1040, in step S1042, the robot 200 receives information on the flight altitudes and the flight radii of other unmanned aerial vehicles from the control server 120.

In step S1044, the robot 200 limits at least one of the flight altitude or the flight range of the unmanned aerial vehicle 810 communicatively connected to the robot 200 based on the received information.

In step S1046, the robot 200 controls the unmanned aerial vehicle 810 so as to fly along the determined route within the limited flight altitude or flight range.

Although not illustrated in FIG. 10, as described above, when the limited flight altitude or flight range does not cover the destination, the robot 200 may cooperate with another robot to guide the user to the destination.

Referring back to FIG. 2, in an embodiment, the robot 200 may further include a learning processor 290 in order to perform an operation related to artificial intelligence and/or machine learning.

Artificial intelligence refers to a field of studying artificial intelligence or a methodology for creating the same. Moreover, machine learning refers to a field of defining various problems dealing in an artificial intelligence field and studying methodologies for solving the same. In addition, machine learning may be defined as an algorithm for improving performance with respect to a task through repeated experience with respect to the task.

An artificial neural network (ANN) is a model used in machine learning, and may refer in general to a model with problem-solving abilities, composed of artificial neurons (nodes) forming a network by a connection of synapses. The ANN may be defined by a connection pattern between neurons on different layers, a learning process for updating a model parameter, and an activation function for generating an output value.

The ANN may include an input layer, an output layer, and may selectively include one or more hidden layers. Each layer includes one or more neurons, and the artificial neural network may include synapses that connect the neurons to one another. In an ANN, each neuron may output a function value of an activation function with respect to the input signals inputted through a synapse, weight, and bias.

A model parameter refers to a parameter determined through learning, and may include weight of synapse connection, bias of a neuron, and the like. Moreover, a hyperparameter refers to a parameter which is set before learning in a machine learning algorithm, and includes a learning rate, a number of repetitions, a mini batch size, an initialization function, and the like.

The objective of training an ANN is to determine a model parameter for significantly reducing a loss function. The loss function may be used as an indicator for determining an optimal model parameter in a learning process of an artificial neural network.

The machine learning may be classified into supervised learning, unsupervised learning, and reinforcement learning depending on the learning method.

Supervised learning may refer to a method for training an artificial neural network with training data that has been given a label. In addition, the label may refer to a target answer (or a result value) to be guessed by the artificial neural network when the training data is inputted to the artificial neural network. Unsupervised learning may refer to a method for training an artificial neural network using training data that has not been given a label. Reinforcement learning may refer to a learning method for training an agent defined within an environment to select an action or an action order for maximizing cumulative rewards in each state.

Machine learning of an artificial neural network implemented as a deep neural network (DNN) including a plurality of hidden layers may be referred to as deep learning, and the deep learning is one machine learning technique. Hereinafter, the meaning of machine learning includes deep learning.

The learning processor 290 may allow a model, composed of an artificial neural network to be trained using learning data. Here, the trained artificial neural network may be referred to as a trained model. The trained model may be used to infer a result value with respect to new input data rather than learning data, and the inferred value may be used as a basis for a determination to perform an operation.

The learning processor 290 may learn the artificial neural network by using one or more of the various parameters used to determine the projection area as learning data.

In an embodiment, the learning processor 290 may learn the artificial neural network by using the position of the robot 200, the destination information included in the guidance request, the map information of the space, the information on the projectable surfaces, and the determined projection area as learning data.

In an embodiment, the learning processor 290 may determine the projection area by using any combination of the position of the robot 200, the destination information included in the guidance request, and the information on projectable surfaces as input data for the learning model based on the artificial neural network.

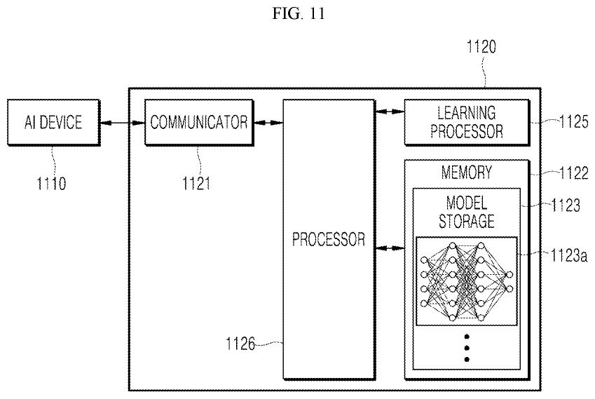

The learning processor 290 may perform artificial intelligence or machine learning processing together with a learning processor 1125 of an AI server 1120 of FIG. 11. The learning processor 290 may include a memory integrated or implemented in the robot 200. Alternatively, the learning processor 290 may be implemented by using the memory 280, an external memory directly coupled to the robot 200, or a memory maintained in an external device.

FIG. 11 is a diagram illustrating a robot system according to still another embodiment of the present disclosure. In an embodiment, the robotic system may be implemented as an AI system capable of artificial intelligence and/or machine learning. Referring to FIG. 11, a robot system according to another embodiment of the present disclosure may include an AI device 1110 and the AI server 1120.

In an embodiment, the AI device 1110 may be the robot 110, the control server 120, the terminal 130 of FIG. 1, or the robot 200 of FIG. 2. The AI server 1120 may be the control server 120 of FIG. 1.

The AI server 1120 may refer to a device using a trained artificial neural network or a device training an artificial neural network by using a machine learning algorithm. The AI server 1120 may be composed of a plurality of servers to perform distributed processing. The AI server 1120 is included as a partial configuration of the AI device 1110 and may perform at least partial artificial intelligence or machine learning processing.

The AI server 1120 may include a communicator 1121, a memory 1122, a learning processor 1125, and a processor 1126.

The communicator 1121 may transmit and receive data with an external device such as the AI device 1110.

The memory 1122 may include a model storage 1123. The model storage 1123 may store a model (or an artificial neural network 1123a) learning or learned via the learning processor 1125.

The learning processor 1125 may train the artificial neural network 1123a by using learning data. The learning model may be used while mounted in the AI server 1120 of the artificial neural network, or may be used while mounted in an external device such as the AI device 1110.

The learning model may be implemented as hardware, software, or a combination of hardware and software. When a portion or the entirety of the learning model is implemented as software, one or more instructions, which constitute the learning model, may be stored in the memory 1122.

The processor 1126 may infer a result value with respect to new input data by using the learning model, and generate a response or control command based on the inferred result value.

The example embodiments described above may be implemented through computer programs executable through various components on a computer, and such computer programs may be recorded on computer-readable media. For example, the recording media may include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present application (especially in the appended claims), the terms “a/an” and “the” include both singular and plural references, unless the context clearly conditions otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Accordingly, it should be understood that the scope of the present disclosure is not limited to the example embodiments described above or by the use of such terms unless limited by the appended claims. Accordingly, it should be understood that the scope of the present disclosure is not limited to the example embodiments described above or by the use of such terms unless limited by the appended claims. Also, it should be apparent to those skilled in the art that various alterations, substitutions, and modifications may be made within the scope of the appended claims or equivalents thereof.

The present disclosure is not limited to the example embodiments described above, and rather intended to include the following appended claims, and all modifications, equivalents, and alternatives falling within the spirit and scope of the following claims.

What is claimed is:

1. A method of providing a guidance service by a robot, comprising:
receiving a guidance request from a user;
determining a route to a destination based on the received guidance request;
determining a field of vision based on the movement direction of the determined route;
determining a projection area based on the determined field of vision and information on projectable surfaces; and
projecting a laser beam indicating guidance information onto the determined projection area.

2. The method of claim 1, wherein the information on the projectable surfaces comprises coordinates indicating the boundaries of the projectable surfaces and an azimuth indicating the orientation of the projectable surfaces.

3. The method of claim 1, wherein the projectable surfaces comprise surfaces of a ceiling, a column, a wall, a handrail, or a floor.

4. The method of claim 1, wherein the determining the projection area comprises determining an area of the projectable surfaces included in the determined field of vision as the projection area.

5. The method of claim 1, further comprising determining the guidance information based on at least one of the position or the area of the determined projection area,
wherein the guidance information comprises at least one of information on the destination, a distance to the destination, an estimated arrival time to the destination, a direction indication for guiding the determined route, a summary description for guiding the determined route, or landmark information.

6. The method of claim 1, wherein the projecting the laser beam comprises at least one of:
determining a projection time of the laser beam based on an estimated arrival time to the destination; or
determining a projection intensity of the laser beam based on the distance to the determined projection area.

7. The method of claim 1, further comprising,
when the projection area may not be determined:
determining an area of the projectable surfaces not included in the field of vision as an alternative projection area.

8. The method of claim 7, further comprising moving to a position where the robot can project the laser beam to the alternative projection area, along the determined route.

9. The method of claim 7, further comprising determining an alternative route to the destination based on the alternative projection area.

10. The method of claim 1, further comprising,
when the projection area may not be determined:
receiving information on flight altitudes and flight ranges of other unmanned aerial vehicles in flight by other robots from a control server;
limiting at least one of the flight altitude or the flight range of at least one unmanned aerial vehicle communicatively connected to the robot based on the received information; and
controlling the at least one unmanned aerial vehicle so as to fly along the determined route within the limited flight altitude or flight range.

11. The method of claim 10, further comprising:
determining whether the limited flight altitude or flight range covers the destination; and
transmitting a cooperation request to another robot configured to control another unmanned aerial vehicle capable of covering the destination, based on the determination that the limited flight altitude or flight range does not cover the destination,
wherein the another unmanned aerial vehicle flies to the destination along the remaining routes of the determined route on behalf of the at least one unmanned aerial vehicle, in response to the cooperation request.

12. A robot, comprising:
a user interface configured to receive a guidance request from a user;
a beam driver configured to generate a laser beam;
a memory configured to store information on projectable surfaces; and
a controller configured to:
determine a route to a destination based on the guidance request,
determine a field of vision based on the movement direction of the determined route,
determine a projection area based on the determined field of vision and information on the projectable surfaces, and
control a beam driver so that a laser beam indicating guidance information is projected onto the determined projection area.

13. The robot of claim 12, wherein the information on the projectable surfaces comprises coordinates indicating the boundaries of the projectable surfaces and an azimuth indicating the orientation of the projectable surfaces.

14. The robot of claim 12, wherein the projectable surfaces comprise surfaces of a ceiling, a column, a wall, a handrail, or a floor.

15. The robot of claim 12, wherein the controller is further configured to determine an area of the projectable surfaces included in the determined field of vision as the projection area.

16. The robot of claim 12, wherein the controller is further configured to determine the guidance information based on at least one of the position or the area of the determined projection area,
wherein the guidance information comprises at least one of information on the destination, a distance to the destination, an estimated arrival time to the destination, a direction indication for guiding the determined route, a summary description for guiding the determined route, or landmark information.

17. The robot of claim 12, wherein the controller is further configured to determine a projection time of the laser beam based on an estimated arrival time to the destination, and to determine a projection intensity of the laser beam based on the distance to the determined projection area.

18. The robot of claim 12, wherein, when the projection area may not be determined, the controller is further configured to determine an area of the projectable surfaces not included in the field of vision as an alternative projection area.

19. The robot of claim 12, wherein, when the projection area may not be determined, the controller is further configured to:
receive information on flight altitudes and flight ranges of other unmanned aerial vehicles in flight by other robots from a control server,
limit at least one of the flight altitude or the flight range of at least one unmanned aerial vehicle communicatively connected to the robot based on the received information, and
control the at least one unmanned aerial vehicle so as to fly along the determined route within the limited flight altitude or flight range.

20. The robot of claim 19, wherein the controller is further configured to:
determine whether the limited flight altitude or flight range may cover the destination, and
transmit a cooperation request to another robot configured to control another unmanned aerial vehicle capable of covering the destination, based on the determination that the limited flight altitude or flight range does not cover the destination, and
wherein the another unmanned aerial vehicle flies to the destination along the remaining routes of the determined route on behalf of the at least one unmanned aerial vehicle, in response to the cooperation request.
